(19) United States
(12) Patent Application Publication
(10) Pub. No.: US 2010/0001139 A1
(43) Pub. Date: Jan. 7, 2010

(54) SWIVELING PENDANT ASSEMBLIES FOR AERIALLY TRANSPORTING CARGO AND ASSOCIATED METHODS OF USE AND MANUFACTURE

(76) Inventors: Todd Humbert, Chandler, AZ (US); Dennis W. Gaibler, Wilsonville, OR (US)

Correspondence Address: PERKINS COIE LLP;PATENT-SEA, P.O. BOX 1247, SEATTLE, WA, 98111-1247, US

(21) Appl. No.: 12/366,587

(22) Filed: Feb. 5, 2009

Related U.S. Application Data
(60) Provisional application No. 61/026,455, filed on Feb. 5, 2008.

(51) Int. Cl. B64D 1/12

(52) U.S. Cl. 244/137.4

(57) ABSTRACT

Cargo pendant assemblies for transporting cargo with aircraft and other cargo movers are disclosed herein. A pendant assembly configured in accordance with one embodiment of the disclosure includes a pendant line having a first end portion opposite a second end portion. The second end portion is configured to be releasably attached to the aerial vehicle or other type of cargo transporter. The pendant assembly also includes a swivel attached to the first end portion of the pendant line, and a hook attached to the swivel. The hook is configured to releasably retain the cargo and rotate about the swivel independent of the pendant line and without twisting the pendant line. The pendant assembly further includes a release actuator that extends through at least a portion of the swivel and is operably coupled to the hook. The release actuator allows a user to release the cargo from the hook.

### CROSS REFERENCE TO RELATED APPLICATION

This application claims the benefit of U.S. Provisional Application No. 61/026,455, filed Feb. 5, 2008, titled “IMPROVED AERIAL TRANSPORT APPARATUS,” the entirety of which is incorporated herein by reference.

### BACKGROUND

The disclosure relates generally to systems and assemblies for aerially transporting cargo and, more specifically, to swivel hook assemblies that allow cargo to freely rotate without twisting a pendant line carrying the cargo.

### DESCRIPTION OF RELATED ART

The size of an aircraft's cargo opening or cargo doors typically limit the size of the cargo that can be loaded into the aircraft. For example, cargo typically cannot be loaded into the aircraft if the cargo has overall external dimensions that exceed the corresponding dimensions of the aircraft's cargo doors. Therefore, oversized or odd shaped cargo such as timber, vehicles, and large containers generally cannot be loaded and transported internally the aircraft.

Aerial transport systems have accordingly been developed for transporting oversized cargo with sling assemblies. Such assemblies are frequently used with helicopters, for example, to transport large or bulky goods externally to the aircraft. While external cargo sling assemblies may enhance the versatility of the aircraft, these assemblies can also impact the performance of the aircraft. For example, one disadvantage of conventional external cargo sling assemblies is that their components add both weight and drag to the aircraft. Drag is a particular problem for aircrafts that are capable of high speed flight. Externally attached cargo is typically suspended some distance below the aircraft in a pendant configuration, with the aircraft acting as a support for the pendant. The weight and bulk of the pendant cargo load can reduce the aircraft speed and fuel efficiency of the aircraft. The added weight is also particularly problematic for aircraft that are not dedicated cargo transporters, but that are used occasionally for transporting cargo. For these aircraft, pendant assemblies can add considerable weight, even when stowed on the aircraft, thereby decreasing the fuel efficiency of the aircraft.

### BRIEF DESCRIPTION OF THE DRAWINGS

FIG. 1 is a side view of an aircraft carrying a cargo pendant assembly configured in accordance with an embodiment of the disclosure.

FIG. 2 is a side view and FIGS. 3 and 4 are isometric views of a cargo hook assembly configured in accordance with an embodiment of the disclosure.

FIG. 5 is a partial isometric view of the cargo hook assembly of FIGS. 2-4.

FIG. 6 is a side view and FIG. 7 is a front view of a side plate of the cargo hook assembly of FIGS. 2-5.

FIG. 8 is a side view of a spacer of the cargo hook assembly of FIGS. 2-5.

FIG. 9A is an isometric view of a pendant assembly configured in accordance with another embodiment of the disclosure.

FIGS. 9B and 9C are enlarged views of portions of the pendant assembly of FIG. 9A.

FIG. 10 is an isometric cross-sectional view of a pendant assembly configured in accordance with another embodiment of the disclosure.

FIG. 11A is an isometric cross-sectional view, and FIGS. 11B and 11C are side cross-sectional views of pendant assemblies configured in accordance with further embodiments of the disclosure.

### DETAILED DESCRIPTION

Sling or pendant assemblies for aerially transporting cargo with a cargo mover and associated methods of using and making such assemblies are described in detail herein in accordance with embodiments of the present disclosure. Certain details are set forth in the following description and Figures to provide a thorough and enabling description of various embodiments of the disclosure. Other details describing well-known structures and components often associated with cargo pendant assemblies, however, are not set forth below to avoid unnecessarily obscuring the description of various embodiments of the disclosure.

Many of the details, dimensions, angles, relative sizes of components, and/or other features shown in the Figures are merely illustrative of particular embodiments of the disclosure. Accordingly, other embodiments can have other details, dimensions, angles, sizes, and/or features without departing from the spirit and scope of the present disclosure. Moreover, certain features described with reference to specific embodiments may be combined with other embodiments of the disclosure. In addition, further embodiments of the disclosure may be practiced without several of the details described below, while still other embodiments of the disclosure may be practiced with additional details and/or features.

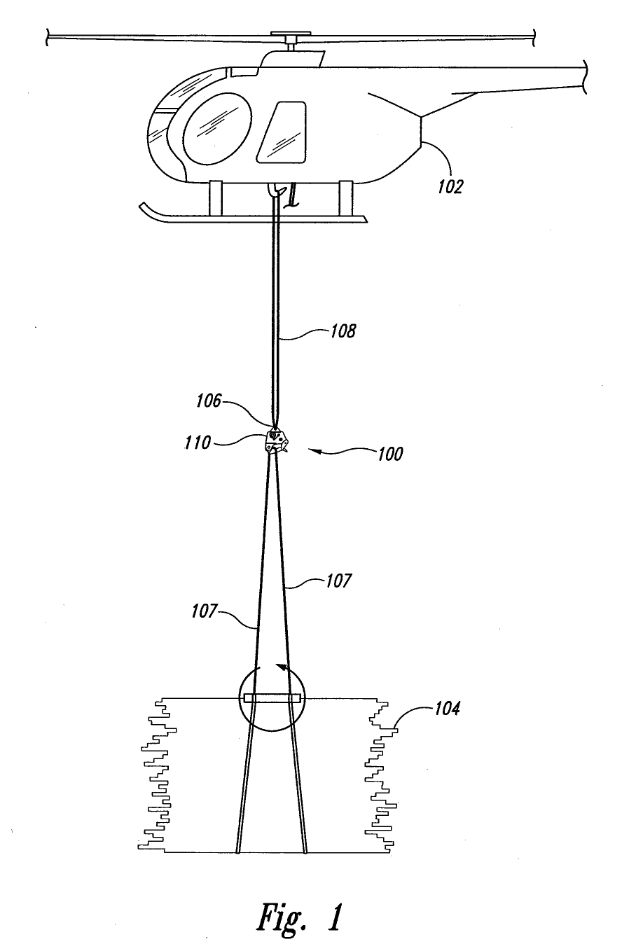

FIG. 1 is a side view of an aircraft 102 carrying a cargo pendant assembly 100 configured in accordance with an embodiment of the disclosure. The aircraft 102 shown in FIG. 1 is a helicopter. In other embodiments, however, the aircraft 102 can include any aircraft or aerial vehicle, such as an airplane, jet, etc., and is not limited to a helicopter. Moreover, in still further embodiments, the pendant assembly 100 can be used with any type of cargo mover, including, for example, a crane or similar cargo moving devices. In the illustrated embodiment the pendant assembly 100 includes a swivel assembly 106 operably coupled to a hook assembly 110. The swivel assembly 106 is attached to one or more pendant lines 108 extending from the aircraft 102. The hook assembly 110 is releasably attached to one or more load lines 107 carrying a cargo load 104. As explained in detail below, the hook assembly 110 is configured to allow a user in the aircraft 102 to release the cargo 104 from the hook assembly 110. Moreover, the swivel assembly 106 is configured to allow the hook assembly 110 and cargo 104 to rotate independent of the pendant lines 108.

In certain embodiments, the hook assembly 110 can accommodate cargo 104 having a maximum weight of about 12,500 kilograms (about 26,000 pounds). In other embodiments, the hook assembly 110 can accommodate cargo 104 having a maximum weight that is greater than 12,500 kilograms. Moreover, the pendant assembly 100 can be stowed at least partially within the aircraft 102 when the pendant assembly 100 is not in use. Stowing the pendant assembly 100, and in particular the hook assembly 110, in the aircraft 102 reduces the drag on the aircraft 102 thereby enhancing the operating efficiency of the aircraft 102 (e.g., higher operating flight speeds, lower fuel consumption, etc.).

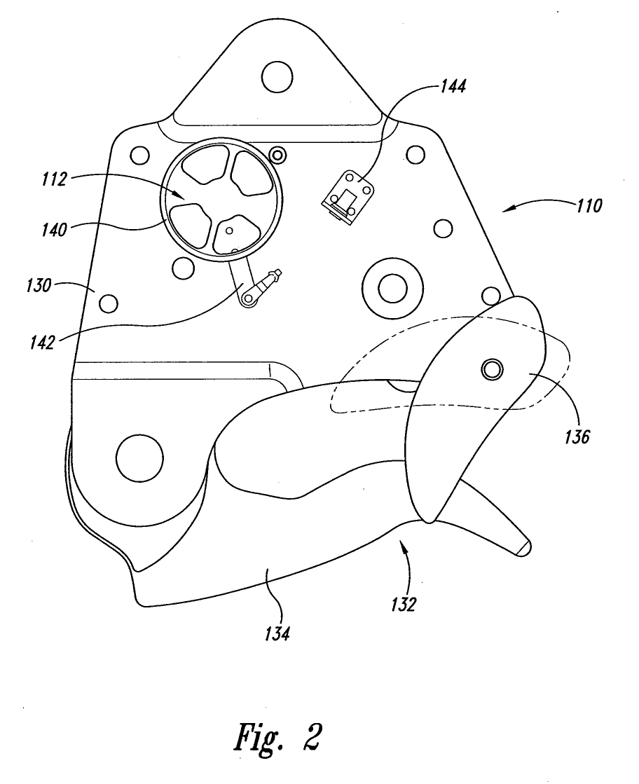

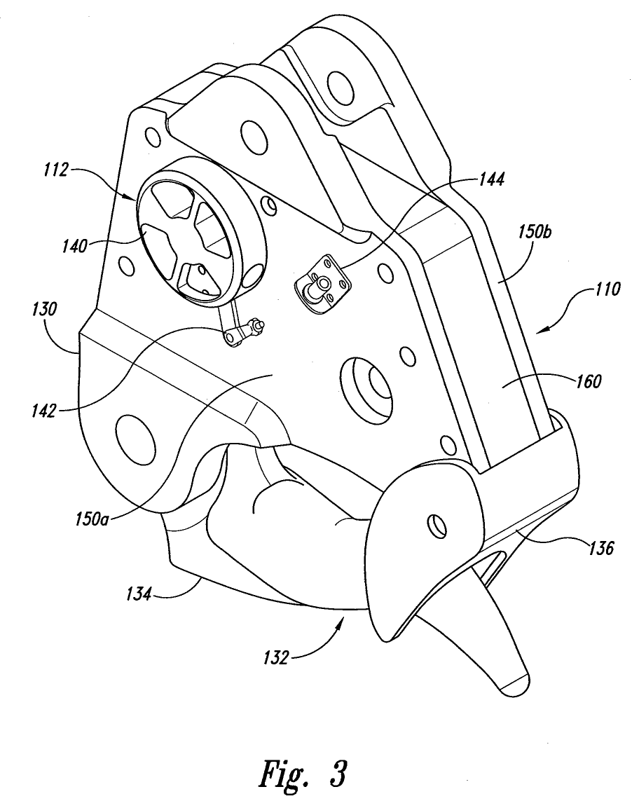

FIG. 2 is a side view and FIGS. 3 and 4 are isometric views of the hook assembly 110 of FIG. 1. Referring to FIGS. 2-4 together, the hook assembly 110 includes a hook body 130 including a cargo engagement unit 132 and a cargo release system 112. As explained in detail below, the cargo release system 112 can be manually and remotely actuated by a user in an aircraft. For example, flight crew, such as a pilot or co-pilot, can actuate the cargo release system 112 from a cockpit to release cargo from the hook assembly 110.

In the illustrated embodiment, the cargo engagement unit 132 includes a load arm 134 extending from the body 130, and a keeper 136 pivotally attached to the body 130. The load arm 134 is configured to engage cargo (e.g., with cargo lines extending from the cargo). The keeper 136 is configured to retain cargo on the load arm 134 and to release the cargo from the load arm 134. For example, the keeper 136 pivots on the body 130 between an open position (shown in broken lines in FIG. 2) to allow the load arm 134 to engage or release the cargo, and a closed position (shown in solid lines in FIGS. 2-4) to preclude attached cargo from inadvertently disengaging from the hook assembly 110 during transport. The cargo engagement unit 132 is operably coupled to the cargo-release system 112. As such, a user can actuate the cargo release system 112 to move the keeper 136 from the closed position to the open position and release cargo from the load arm 134.

According to another feature of the illustrated embodiment, the cargo-release system 112 includes a pulley 140 carried by the body 130 and operably coupled to the keeper 136. The cargo release system 112 also includes an extension member 142 projecting radially outward from the pulley 140, and a cable router 144 on the body 130 spaced apart from the extension member 142. The cargo release system 112 is configured so that a first end portion of a cable or other type of release actuator can pass through the cable router 144 and attach to the extension member 142. The opposite end portion of the cable can terminate in the aircraft so that a user can actuate the cargo release system 112 from the aircraft. More specifically, a user can pull the cable from the aircraft, and the cable will rotate the extension member 142 to spin the pulley 140 in a first direction (e.g., in a counter clockwise direction) to pivot the keeper 136 from the closed position to the open position. In certain embodiments, the pulley 140 can be biased or spring loaded so that when the user releases the cable, the pulley 140 rotates in a second direction opposite the first direction (e.g., in a clockwise direction) to pivot the keeper 136 from the open position to the closed position. Although a user can actuate the cargo release system 112 with a cable, in other embodiments and as described in detail below, the release system 112 can include other actuating mechanisms, including, for example, hydraulic or electrical actuating mechanisms.

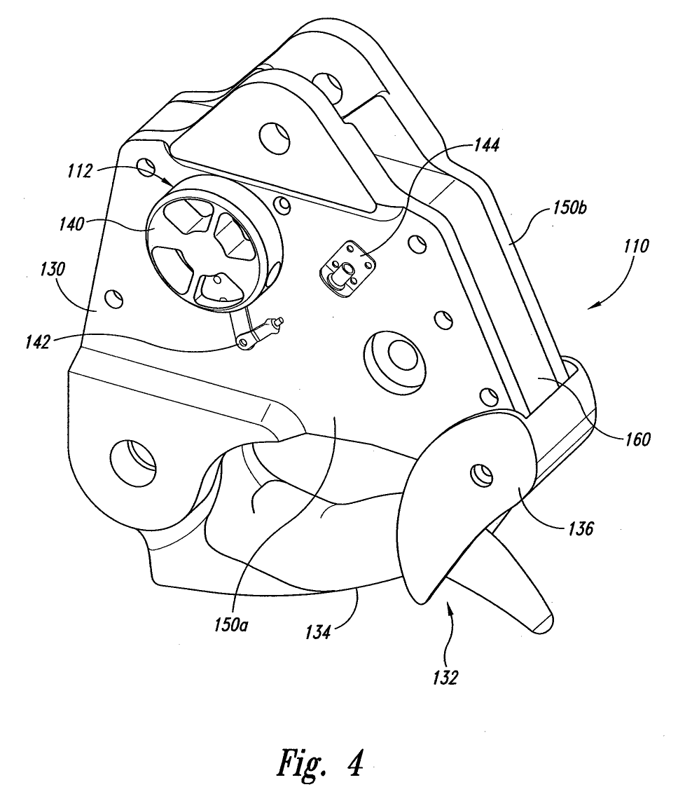

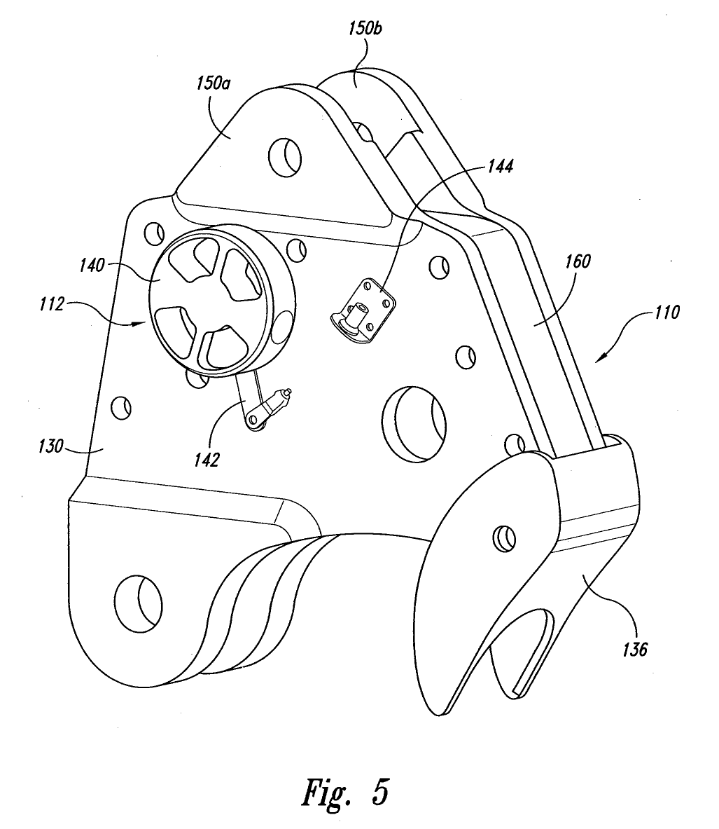

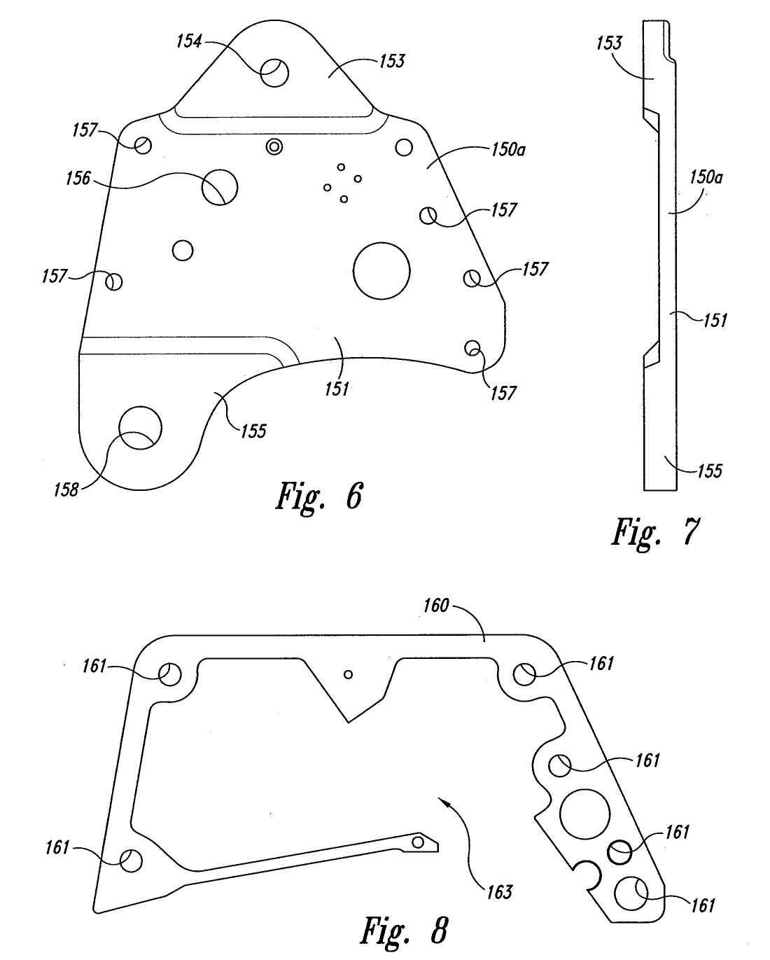

FIG. 5 is an isometric view of the hook assembly 110 with the load arm 134 removed from the body 130. According to another feature of the illustrated embodiment, and as shown in FIGS. 2-5, the main body 130 includes side plates 150 (identified individually as a first side plate 150a and a second side plate 150b) spaced apart from one another by a spacer 160. As explained in detail below with reference to FIGS. 6-8, the side plates 150 and spacer 160 are configured to provide several weight saving features while still maintaining the strength of the hook assembly 110.

FIG. 6 is a side view and FIG. 7 is a front view of the first side plate 150a of the hook assembly 110. The second side plate 150b shown in FIGS. 3-5 is a mirror image of first side plate 150a, and includes the same features as the first side plate 150a. Referring to FIGS. 6 and 7 together, the first side plate 150a includes a swivel attachment portion 153 extending from a middle portion 151, and a load arm attachment portion 155 extending from the middle portion 151 opposite the swivel attachment portion 153. The swivel attachment portion 153 includes a first opening 154 for receiving a fastener to attach to the swivel assembly 106 (FIG. 1). The load arm attachment portion 155 includes a second opening 158 for receiving a fastener to attach to the load arm 134 (FIGS. 2-4). The middle portion 151 includes a third opening 156 to attach to the cargo release system 112, and a plurality of apertures 157 to receive fasteners to attach to the spacer 160 (FIGS. 2-5).

According to another feature of the illustrated embodiment, and as particularly shown in FIG. 7, the middle portion 151 has a reduced thickness compared to the load bearing portions of the swivel attachment portion 153 and the load arm attachment portion 155. The reduced width of the middle portion 151 results in a reduced weight of the first side plate 150a, which in turn reduces the overall weight of the hook assembly 110 (FIGS. 1-4).

FIG. 8 is a side view of the spacer 160. As seen from the illustrated embodiment, the spacer 160 is configured to be made from a relatively small amount of material compared to the side plates 150 (FIGS. 6 and 7). More specifically, the spacer 160 is configured to engage or otherwise attach to the periphery of the side plates 150. The spacer 160 includes multiple spacer apertures 161 that are aligned with the corresponding apertures 157 in the side plates 150 (FIG. 6) to receive fasteners to attach these components. The spacer 160 also includes an interior open region 163. As such, when the spacer 160 is positioned between the side plates 150, the spacer 160 provides a relatively large area of open space between the side plates 150 at the open region 163 of the spacer 160, thereby reducing both the amount of material and overall weight of the cargo hook assembly 110 (FIGS. 1-4).

The cargo hook assembly 110 described above with reference to FIGS. 1-8, and in particular the side plates 150, load arm 134, keeper 136, and spacer 160, can be produced from one or more of a variety of lightweight yet strong materials. In certain embodiments, for example, these components can be made from high strength metals and alloys such as y-titanium aluminides, aluminum-metal-matrix-composites, aluminum alloys (e.g., 7075-T6 aluminum alloy), titanium, steel, reinforced composite materials, and the like. In one embodiment, for example, the cargo hook assembly 110 can weigh as little as 45 pounds, or less, and be strong enough to support a cargo load of about 26,000 pounds. In other embodiments, the cargo hook assembly 110 can weigh greater than 45 pounds.

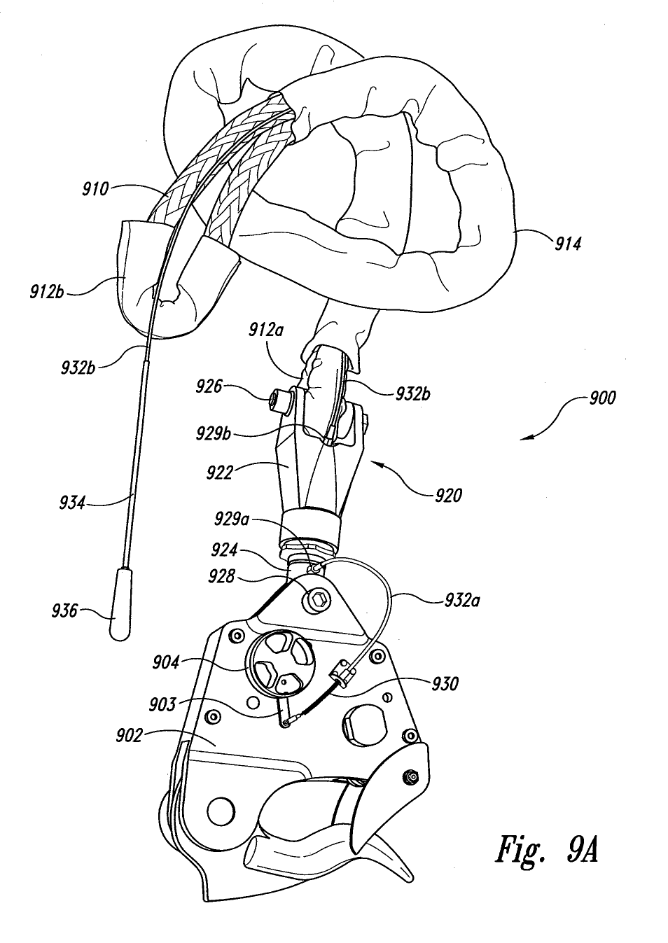

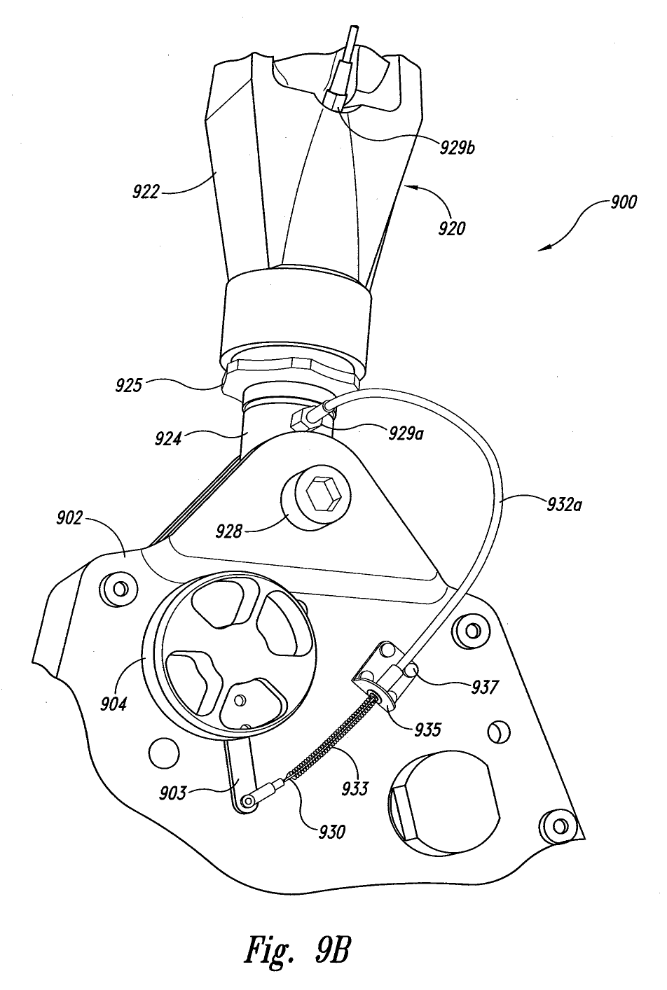

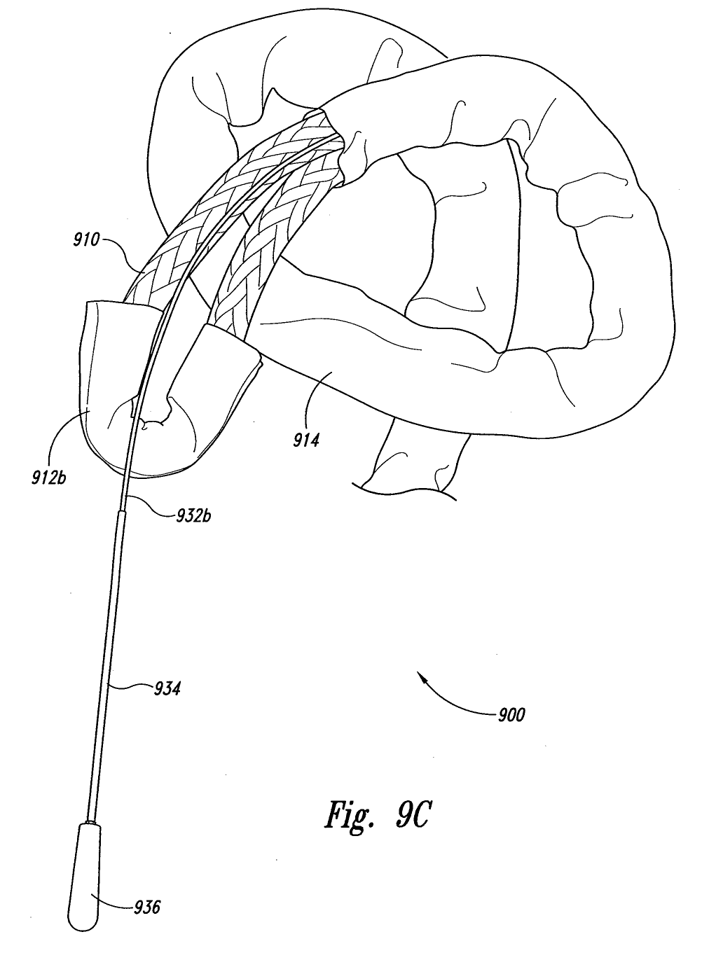

FIG. 9A is an isometric view of a pendant assembly 900 configured in accordance with an embodiment of the disclosure. FIGS. 9B and 9C are enlarged views of portions of the pendant assembly 900 of FIG. 9A. Referring first to FIG. 9A, the illustrated embodiment of the pendant assembly 900 includes a swivel assembly 920 coupling a rope 910 to a cargo hook assembly (“hook”) 902. The swivel assembly 920 allows the hook 902 to rotate independent of the rope 910. In certain embodiments, the swivel assembly 920 can be used with a hook 902 generally similar in structure and function to the cargo hook assembly 110 described above. In other embodiments, however, the swivel assembly 920 can be used with a hook 902 having other features and/or structures. The pendant assembly 900 further includes a quick release actuator or cable (“cable”) 930 that extends from the hook 902 through the swivel assembly 920 and along the rope 910 to allow a user in the aircraft to manually release the hook 902.

In the illustrated embodiment, the rope 910 is made from a woven high strength synthetic material (e.g., a Plasma 12 strand rope). In other embodiments, the rope 910 can include other materials, including, for example, a metallic cable, a rope made from natural materials, combinations of natural and synthetic materials, etc. The rope 910 also includes end portion covers 912 (identified individually as a first end portion cover 912a and a second end portion cover 912b) that protect looped end portions of the rope 910. For example, the first end portion cover 912a covers the rope 910 at the attachment point with the swivel assembly 920, and the second end portion cover 912b protects the rope 920 at the attachment point with the aircraft (not shown in FIGS. 9A-9B). The end portion covers 912 can be made from synthetic or natural materials, including, for example, a woven fabric, leather, etc. The rope 910 further includes a mid-portion cover 914 extending along an intermediate segment of the rope 910. The mid-portion cover 914 can be made from a lightweight and flexible material (e.g., Spectra, Kevlar, etc.) to protect the rope 910 and cable 930 positioned along the rope 910. The mid-portion cover 914 can be fixedly or removably attached to itself around the rope 910. For example, the mid-portion cover 914 can be sewn and/or include buttons, snaps, zippers, hook and loop fasteners, etc. One skilled in the art will appreciate that the embodiments of the rope 910, end portion covers 912, and mid-portion cover 914 are not limited to the materials or configurations described above.

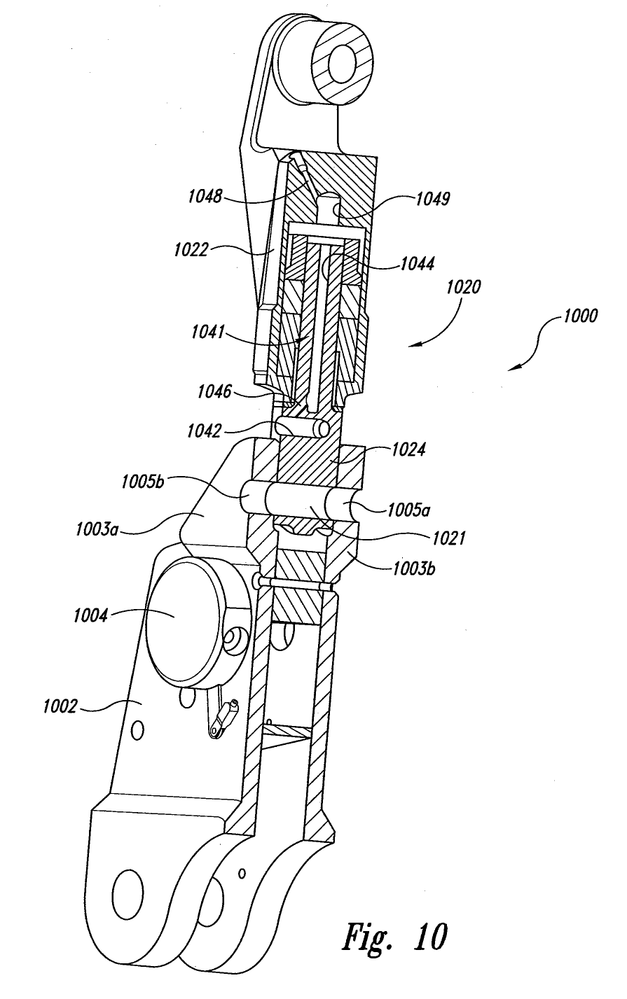

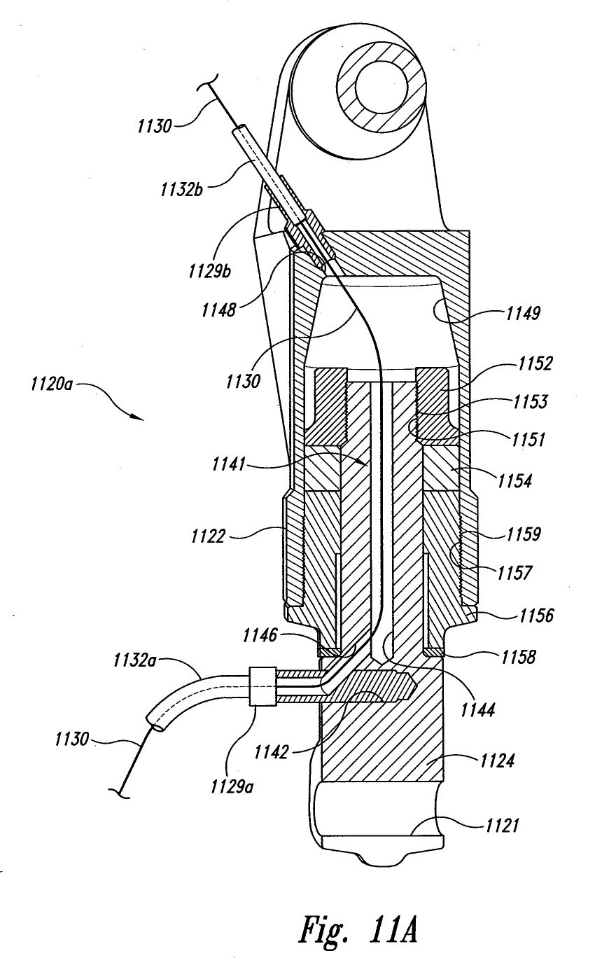

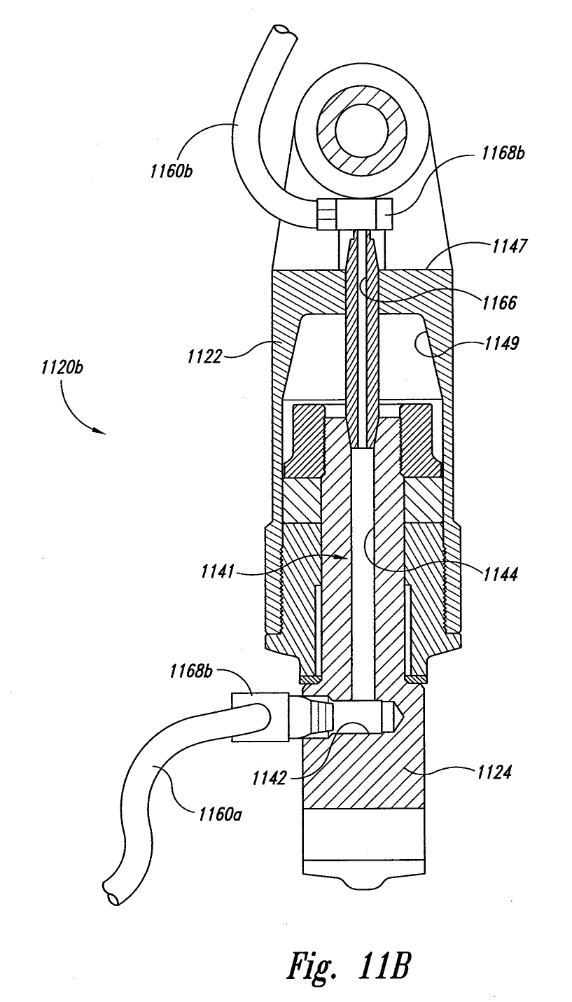

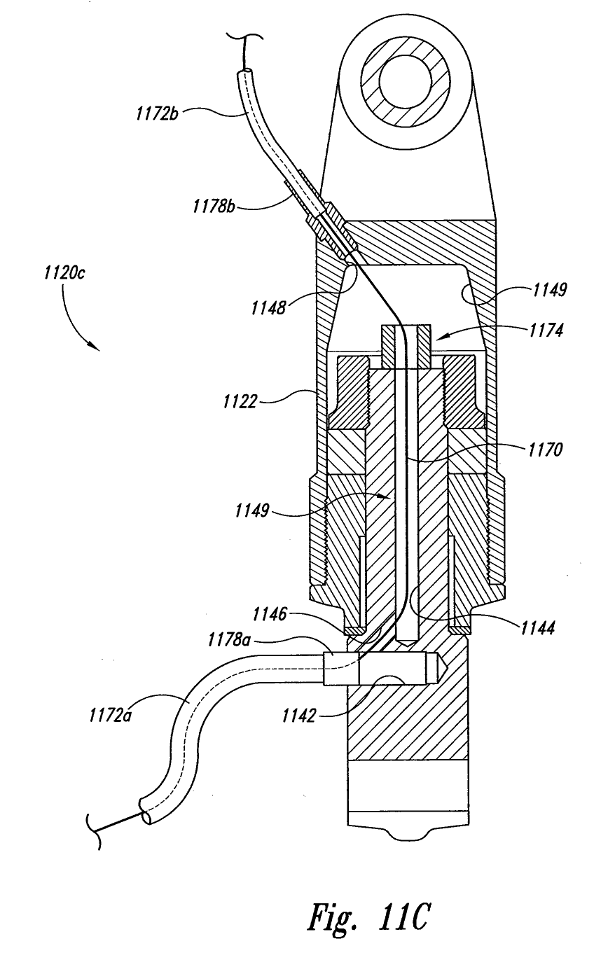

The rope 910 is attached to the swivel assembly 920 with a first pin or bolt 926 that passes through the looped end portion of the rope 910. The first bolt 926 also passes through an upper portion of a swivel body 922 of the swivel assembly 920. The swivel body 922 does not rotate with reference to the rope 910, however, the swivel assembly 920 includes a rotating member or stud 924 that freely rotates with reference to the swivel body 922. In certain embodiments, the swivel body 922 is made from a forged aluminum alloy, and the rotating stud 924 is made from a high strength forged alloy steel. In other embodiments, the swivel body 922 and the rotating stud 924 can be made from other suitable materials known in the art. As described in more detail with reference to FIGS. 10-11C, the rotating stud 924 is connected to the swivel body 922 with a thrust bearing to allow the rotation therebetween. The rotating stud 924 is also attached directly to the hook 902 with a second pin or bolt 928. As such, the swivel assembly 920 enables the hook 902 to rotate or twist independently of the rope 910. The swivel assembly 920 also includes couplings 929 (identified individually as a first coupling 929a and a second coupling 929b) to allow the cable 930 (or other release mechanisms) to enter and exit the swivel assembly 920. In certain embodiments, the first coupling 929a can be positioned on a portion of the rotating stud 924 that protrudes laterally from the rotating stud 924. The second coupling 929a can be positioned on an upper portion of the swivel body 922 proximate to the rope 910.

In the embodiment illustrated in FIG. 9A, the cable 930 is attached to an extension 903 of a release mechanism 904 on the hook 902. The release mechanism 904 is configured to release cargo from the hook 902. The cable 930 extends from the hook 902 enclosed in a first sheath 932a, and enters the swivel assembly 920 at the first coupling 929a. The cable 930 continues through the swivel assembly 920 and exits the swivel body 922 at the second coupling 929b. From the second coupling 929b, the cable 930 is enclosed in a second sheath 932b and continues along the rope 910. From the rope 910, the cable is enclosed in a third sheath 934 and is attached to a handle 936. The third sheath 934 and handle 936 extend from the rope 910 into the aircraft body (not shown in FIG. 9A) to allow a user to release the hook from the aircraft body by pulling the handle 936 to actuate the release mechanism 904 with the cable 930. The cable 930 is configured to accommodate for the rotation of the swivel assembly 920 without binding.

FIG. 9B is an enlarged view of a portion of the pendant assembly 900 of FIG. 9A illustrating the connection between the hook 902 and the swivel assembly 920. The embodiment illustrated in FIG. 9B includes a swivel bushing 925 as one of the components of the swivel assembly 920 that rotationally couples the rotating stud 924 to the swivel body 922. Moreover, as illustrated in FIG. 9B, the cable 930 extends from the extension 903 of the release mechanism 904 through a spring or biasing member 933 to a stop member 935 on the hook 902. A plurality of fasteners (e.g., screws, bolts, rivets etc.) attach the stop member 935 to the hook 902. The biasing member 933 at least partially retains the release mechanism 904 in a closed position until the cable 930 is actuated. The cable 930 is enclosed in the first sheath 932a and extends from the stop member 935 to the first coupling 929a on the rotating stud 924. In the illustrated embodiment, the second bolt 928 attaches the rotating stud 924 to the hook 902 such that the hook 902 spins or rotates along with the rotating stud 924. Accordingly, the cable 930 and first sheath 932a do not get twisted between the hook 902 and swivel assembly 920 when the hook 902 rotates or spins during use.

FIG. 9C is an enlarged view of a portion of the pendant assembly 900 of FIG. 9A illustrating the third sheath 934 and handle 936. In the embodiment illustrated in FIG. 9C, the cable 930 (not visible in FIG. 9C) extends through the second sheath 932b from the rope 910 and is enclosed in or otherwise attached to the third sheath 934 and the handle 936. The second sheath 932b (as well as the first sheath 932a illustrated in FIGS. 9A and 9B) can be made from a generally flexible material to allow the cable to bend and flex as it extends along the pendant assembly 900. The third sheath 934 can be made of a generally rigid material, such as aluminum, for example, to extend through an aircraft body. In other embodiments, however, the third sheath 934 can also be made of a flexible material, similar to the first and second sheaths 932a, 932b. FIG. 9C also illustrates a looped end portion of the rope 910, second end portion cover 912b, as well as the mid-portion cover 914.

The embodiment illustrated in FIGS. 9A-9C provides a light weight pendant assembly 900 that allows the hook 902 to rotate or spin without twisting the rope 910. Reducing the weight of the pendant assembly 900 provides the benefit of making it easier to retract the pendant assembly 900 into the aircraft when the hook 902 is not being used. For example, one method of retracting the pendant assembly 900 into the aircraft involves manually hoisting or winching the rope 910, attached swivel assembly 920, and hook 902 into the aircraft. Accordingly, the reduced weight facilitates retracting the pendant assembly 900 into the aircraft. Another advantage of the illustrated embodiment is that the hook 902, along with an attached external load, can rotate independently of the rope 910. The swivel assembly 920 of the present disclosure allows an external load to freely spin during flight without twisting the rope 900. Allowing the hook 902 to rotate independent of the rope 910 also prevents the shortening of the rope 910 due to twisting.

FIG. 10 is an isometric cross-sectional view of a portion of a pendant assembly 1000 configured in accordance with an embodiment of the disclosure. The pendant assembly 1000 is generally similar in form and function to the pendant assembly 1000 described above with reference to FIGS. 9A-9C. For example, the pendant assembly 1000 includes a swivel assembly 1020 attached to a hook 1002 with a release mechanism 1004. The swivel assembly 1020 includes a swivel body 1022 attached to a rotating stud 1024. The cross-sectional view of FIG. 10, however, illustrates several of the features of the swivel assembly 1020. For example, the rotating stud 1024 is attached to the hook 1002 between first and second swivel attachment portions 1003a, 1003b extending from the hook 1002. The rotating stud 1024 includes a first opening 1021 aligned with second and third openings 1005a, 1005b of the first and second swivel attachment portions 1003a, 1003b, respectively. These openings are aligned to receive a pin or bolt to attach the hook 1002 to the rotating stud 1024.

The swivel assembly 1020 also includes a passage 1041 extending through the rotating stud 1024 and swivel body 1022 to allow a cable or other release actuator or mechanisms (e.g., electrical wires, fluid, etc.) to travel through the swivel assembly 1020. For example, in the illustrated embodiment, the rotating stud 1024 includes a first channel 1042 proximate to the hook 1002 and extending into the rotating stud 1024 in a first direction generally transverse to a longitudinal axis of the rotating stud 1024. A second channel 1044 also extends through a portion of the rotating stud 1024 in a second direction generally parallel to the longitudinal axis of the rotating stud 1024. In certain embodiments, the first and second channels 1042, 1044 can intersect to form a passageway through the rotating stud 1024. In other embodiments, however, and as illustrated in FIG. 10, a third channel 1046 extends between and connects the first and second channels 1042, 1044. The swivel assembly 1020 can also include a fourth channel 1048 extending through an upper portion of the swivel body 1022 to intersect a cavity 1049 in the upper portion of the swivel body 1022. The cavity 1049 provides access to the second channel 1044 in the rotating stud 1024. The first channel 1042 and the fourth channel 1048 each provide external access to the passage 1041 extending through the swivel assembly 1020. As such, the configuration of the first, second, third, and fourth channels 1042, 1044, 1046, 1048 can allow a cable, wires, fluid, etc., to pass through an internal portion of the swivel assembly 1020.

FIGS. 11A-11C illustrate several embodiments of swivel assemblies incorporating different hook-release mechanisms or actuators. FIG. 11A is an isometric cross-sectional view of a first swivel assembly 1120a configured in accordance with an embodiment of the disclosure. In the embodiment illustrated in FIG. 11A, the first swivel assembly 1120a is generally similar in structure and function to the swivel assemblies 920, 1020 described above with reference to FIGS. 9A-10. For example, the first swivel assembly 1120a includes a swivel body 1122 attached to a rotating stud 1124, as well as interconnected first, second, third, and fourth channels 1142, 1144, 1146, and 1148, and cavity 1149, thereby forming a passage 1141 through the first swivel assembly 1120a. The embodiment of FIG. 11A, however, also illustrates the attachment of the rotating stud 1124 to the swivel body 1122. More specifically, a flange nut 1152, a thrust bearing 1154, a swivel bushing 1156, and a thrust washer 1158 each surround the rotating stud 1124 and form the attachment with the swivel body 1122 to allow the rotating stud 1124 to freely rotate or twist. The flange nut 1152 has a threaded interior surface 1153 that engages a corresponding threaded exterior surface portion 1151 of the rotating stud 1124. The flange nut 1152 is positioned above the thrust bearing 1154, which is in turn positioned above the swivel bushing 1156. The swivel bushing 1156 has a threaded exterior surface 1157 that engages a corresponding threaded interior surface portion 1159 of the swivel body 1122. The swivel bushing 1156 is positioned above the thrust washer 1158. The thrust bearing 1154 and associated flange nut 1152, swivel bushing 1156, and thrust washer 1158 accordingly provide for the rotational movement of the rotating stud 1124 with reference to the swivel body 1122 to allow the rotating stud 1124 to freely spin.

The embodiment illustrated in FIG. 11A also includes a release mechanism utilizing a quick release cable 1130 that extends through the passage 1141 in the swivel assembly 1120. The cable 1130 is enclosed in a first sheath 1132a that is attached to a first coupling 1129a on the rotating stud 1124 at the first channel 1142. The cable 1130 extends from the first coupling 1129a through the first channel 1142, and continues through the third channel 1146 and the second channel 1144. From the second channel 1144, the cable extends through the cavity 1149 in the upper portion of the swivel body 1122 to the fourth channel 1148. The cable 1130 extends from the fourth channel 1148 into a second sheath 1132b attached to a second coupling 1129b. The embodiment of the swivel assembly 1120a illustrated in FIG. 11A allows the cable 1130 to pass through the rotating stud 1124 and swivel body 1122 such that the rotating stud 1124 can rotate with reference to the swivel body 1122, while the cable 1130 can still be actuated to release cargo from the hook (not shown in FIG. 11A) attached to the swivel assembly 1120.

FIG. 11B is a side cross-sectional view of a second swivel assembly 1120b configured in accordance with another embodiment of the disclosure. The second swivel assembly 1120b is generally similar in structure and function to the first swivel assembly 1120a described above with reference to FIG. 11A. For example, the second swivel assembly includes the rotating stud 1124 attached to the swivel body 1122. In the embodiment illustrated in FIG. 11B, however, the second swivel assembly 1120b includes a release mechanism incorporating a hydraulic fluid line extending through the second swivel assembly 1120b. More specifically, a first hydraulic line 1160a is attached to a first hydraulic coupling 1168a. The first hydraulic coupling 1168a is attached to the rotating stud 1124 at the first channel 1142. In the illustrated embodiment, the second channel 1144 intersects the first channel to form the passage 1141 through the rotating stud 1124. In other embodiments, however, other channels may also be used to form the passage 1141 through the rotating stud 1124 and/or the swivel assembly 1120. A hydraulic conduit 1166 is positioned in the cavity 1149 of the swivel body 1122 and couples the second channel 1144 to a second hydraulic coupling 1168b at an exterior upper surface 1147 of the swivel body 1122. A second hydraulic line 1160b is coupled to the second hydraulic coupling 1168b and extends to the aircraft.

FIG. 11C is a side cross-sectional view of a third swivel assembly 1120c configured in accordance with yet another embodiment of the disclosure. The third swivel assembly 1120c is generally similar in structure and function to the first and second swivel assemblies 1120a, 1120b described above with reference to FIGS. 11A and 11B. In the embodiment illustrated in FIG. 11C, however, the third swivel assembly 1120c includes a release mechanism incorporating an electrical wire 1170 extending through the third swivel assembly 1120c. The electrical wire 1170 extends through a first conduit 1172a that is attached to a first electrical coupling 1178a at the first channel 1142. The electrical wire 1170 continues through the third channel 1146 and the second channel 1144 to an electrical swivel connector 1174 at an upper portion of the rotating stud 1124. From the electrical swivel connector 1174, the electrical wire 1170 extends through the cavity 1149 and the fourth channel 1148 to a second electrical coupling 1178b. From the second electrical coupling 1178b, the electrical wire 1170 extends through a second conduit 1172b from the swivel assembly 1120 to the aircraft.

From the foregoing, it will be appreciated that specific embodiments of the disclosure have been described herein for purposes of illustration, but that various modifications may be made without deviating from the spirit and scope of the various embodiments of the disclosure. Further, while various advantages and features associated with certain embodiments of the disclosure have been described above in the context of those embodiments, other embodiments may also exhibit such advantages and/or features, and not all embodiments need necessarily exhibit such advantages and/or features to fall within the scope of the disclosure. Accordingly, the disclosure is not limited, except as by the appended claims.

I/We claim:

1. A pendant assembly for transporting cargo with an aerial vehicle, the pendant assembly comprising:
a pendant line having first and second end portions, the second end portion being coupleable to the aerial vehicle;
a swivel coupled to the first end portion of the pendant line;
a hook rotatably coupled to the swivel, wherein the hook rotates about the swivel independent of the pendant line and is configured to releasably retain the cargo; and
a release actuator extending through at least a portion of the swivel, wherein the release actuator is operably coupled to the hook to allow the cargo to release from the hook.

2. The pendant assembly of claim 1, further comprising a release subassembly carried by the hook and configured to move at least a portion of the hook to allow the cargo to release from the hook, and wherein the release actuator is attached to the release subassembly.

3. The pendant assembly of claim 1 wherein the hook includes a hook body, a load arm extending from the hook body, and a keeper pivotally coupled to the hook body and movable between a locked position proximate to the load arm and an open position spaced apart from the load arm.

4. The pendant assembly of claim 1 wherein the swivel includes a swivel body and a rotating member, wherein the swivel body is attached to the first end portion of the pendant line, and the rotating member is attached to the hook and rotates with the hook relative to the swivel body and the first end portion of the pendant line.

5. The pendant assembly of claim 4 wherein the swivel further comprises:
a first connector engaged with the swivel body;
a second connector engaged with the rotating member; and
a thrust bearing coupling the first connector to the second connector.

6. The pendant assembly of claim 4 wherein the swivel body includes a cavity and the rotating member includes a passage, and wherein the release actuator extends through the cavity and the passage.

7. The pendant assembly of claim 6 wherein the cavity and the passage are at least generally aligned with one another along a longitudinal axis of the swivel.

8. The pendant assembly of claim 6 wherein the passage is a first passage and the rotating member includes a second passage connected to the first passage extending in a direction generally perpendicular to the first passage.

9. The pendant assembly of claim 6 wherein the release actuator includes a cable, and wherein the hook can rotate about the swivel without twisting the cable around the pendant line.

10. The pendant assembly of claim 6 wherein the release actuator is a hydraulic release actuator, and wherein the cavity and the passages are at least partially filled with an actuating fluid.

11. The pendant assembly of claim 1, further comprising a cover extending along at least an intermediate portion of the pending line, wherein the cover is at least partially made from at least one of Spectra material and Kevlar material.

12. The pendant assembly of claim 1 wherein the pendant line is a plasma 12 strand rope.

13. A pendant assembly for transporting cargo with a pendant line, the pendant assembly comprising:
a swivel having a body attached to the pendant line, a rotating member coupled to the body, and a passage extending through at least a portion of the body and the rotating member, wherein the rotating member rotates about a longitudinal axis of the swivel body;
a hook coupled to the rotating member and configured to retain the cargo, wherein the hook includes a release mechanism for allowing the cargo to release from the hook, and wherein the hook rotates with the rotating member without twisting the pendant line; and
a release actuator operably coupled to the release mechanism for releasing the cargo, wherein the release actuator extends through the passage.

14. The pendant assembly of claim 13 wherein the release actuator is a cable extending from the release mechanism through the swivel, and wherein the cable extends adjacent to at least a portion of the pendant line.

15. The pendant assembly of claim 14 wherein the release mechanism includes a pulley carried by the hook, and wherein the cable is operably coupled to the pulley and rotates the pulley when the cable activates the release mechanism.

16. The pendant assembly of claim 13 wherein the release actuator is a hydraulic release actuator and includes an actuating fluid in the passage.

17. The pendant assembly of claim 13 wherein the release actuator is an electronic release actuator and includes an electrical link extending through the passage.

18. The pendant assembly of claim 13 wherein the hook includes a load arm for engaging the cargo and a keeper for retaining the cargo on the load arm, and wherein the release mechanism pivots the keeper about the hook away form the load arm to an open position to allow the cargo to release in response to activation of the release actuator.

19. A pendant assembly for transporting cargo with a cargo mover, the pendant assembly comprising:
a pendant line having a first end portion spaced apart from a second end portion, wherein the first end portion is configured to be coupled to the cargo mover;
a hook for releasably engaging the cargo; and
means for rotatably coupling the hook to the second end portion of the pendant line so that the hook rotates independently of the pendant line without twisting the pendant line.

20. The pendant assembly of claim 19, further comprising means for remotely releasing the cargo from the hook, wherein the means for remotely releasing the cargo extends through at least a portion of the means for rotatably coupling the hook to the second end portion of the pendant line.

21. The pendant assembly of claim 19 wherein the means for rotatably coupling the hook to the second end portion of the pendant line comprises a swivel including a swivel body coupled to a rotating member, wherein the swivel body is secured to the second end portion of the pendant line, and the rotating member is secured to the hook and rotates independently of the body.
